(19) United States
(12) Patent Application Publication
(10) Pub. No.: US 2020/0023876 A1
(43) Pub. Date: Jan. 23, 2020

(54) COLLAPSIBLE HANDCART

(71) Applicant: Peter Andrew Puleo, JR., Brentwood, MO (US)

(72) Inventor: Peter Andrew Puleo, JR., Brentwood, MO (US)

(21) Appl. No.: 16/038,688

(22) Filed: Jul. 18, 2018

(51) Int. Cl. B62B 3/02; B62B 3/00

(52) U.S. Cl. CPC B62B 3/022; B62B 3/008

(57) ABSTRACT

This invention is directed towards a no-lift gurney style handcart, PTCart, a new and innovative floor transport for heavy items enabling a single person, without lifting, to safely move a fully loaded cart on and off a raised surface, such as a truck bed or loading dock. Improvements over traditional carts consisting of a wheeled support platform include the addition of independently collapsible legs at front and back, plus new and unique safety mechanisms that include a staged leg release and load sensing lift wheel (giving a gurney-like appearance). Needs addressed also include ease of use, simple and robust design, economical to produce, carrying heavy loads (over 500 lbs.), and versatile implementation.

### CROSS REFERENCE TO RELATED APPLICATIONS

Not applicable.

### STATEMENT REGARDING FEDERALLY SPONSORED RESEARCH OR DEVELOPMENT

Not applicable.

### BACKGROUND OF THE INVENTION

This invention generally relates to handcarts, which are wheeled platforms or tables for the manual transportation of objects over a substantially level surface. More particularly, this invention relates to handcarts capable of transporting such objects onto and off of a secondary raised surface such as a truck bed, a loading dock, or a shelf.

Throughout history man has needed to manually move items over the ground and one of his earliest solutions was a table on wheels, variations of which eventually became known as a trolley, barrow, pushcart, or handcart.

Often, the items being transported also need to be taken onto or off of a raised surface such as a loading dock, truck bed, trailer, table, or shelf. The amount of work involved in loading and unloading items between a traditional handcart and a secondary raised surface gave rise to the need for a handcart that could also take its load on and off the raised surface while remaining on the handcart.

This led to the problem of lifting both the handcart and its contents onto and off of the raised secondary surface. One solution to that problem is to maintain the carrying surface and contents at the same height as the raised surface and then collapse the legs as they move onto the secondary surface. However, this traditionally requires the user to carry the weight of the handcart and contents during the transition from the first surface onto the secondary surface. One solution to this resultant problem has been to incorporate independently collapsible legs. Yet, this in turn spawns a variety of difficulties and problems to overcome, such as how and when the legs are collapsed and in what order, especially given the potential danger if one or both collapsed unintentionally while carrying a full load. Further, should only one side collapse, the flat upper surface of the handcart becomes a steep ramp that can dangerously spill the load across the floor or onto the operator.

There have been many attempts to overcome these problems in the past, but such attempts failed, had very specific or limited use, or were otherwise insufficient. Many were based on hospital gurney stretchers designed to carry a single person lying flat and could not handle heavier loads, had legs placed toward the center instead of at the ends causing instability when unevenly loaded, or required the operator to bear half the weight and needed more than one operator for heavy loads. Some had overly complex designs making them prone to breakdown, expensive to produce and/or difficult to operate. Some were designed with an automatic leg release and could collapse simply by bumping into a low object such as a toolbox or wall. Some used a release handle without a safety and could collapse if someone accidentally leaned on it or pulled the handcart with it.

Therefore, a need exists for a handcart that is capable of transferring onto and off of a raised surface quickly, easily, and safely while fully loaded.

In recognition of these continuing needs, the handcart of the instant disclosure is designed to safely transition to and from the floor and a raised surface while carrying a heavy load (e.g., over 500 lbs.) by a single person with virtually no lifting. In addition to heavy loads, the handcart of the present disclosure also accommodates a wide range of table lengths and widths and therefore has great versatility to accept various attachments such as, for example, a sound system, a snow cone machine, or even a BBQ pit and a cooler for tailgate parties. Finally, the handcart of the present disclosure has a very simple mechanical design making it reliable, easy to operate, and economical to produce.

### BRIEF DESCRIPTION OF THE DRAWINGS

The illustrative embodiments of the present invention are shown in the following drawings which form a part of the specification:

FIG. 1A is a side view of a representative embodiment of a handcart of the present invention carrying various items while being pushed at ground level by a user;

FIG. 1B is a side view of the handcart of FIG. 1A carrying various items and transitioned atop a secondary raised surface with its legs collapsed while being pushed by a user;

FIG. 2 is a side view of the handcart of FIG. 1A with the legs extended.

FIG. 3 is a bottom view of the handcart of FIG. 1A showing the undercarriage linkage of the handcart;

FIG. 4A is a rear view of the handcart of FIG. 1A showing the rear leg assembly of the handcart;

FIG. 4B is a side view of the rear leg assembly of the handcart of FIG. 1A, showing the wire brace and spring at rest against the rear leg assembly;

FIG. 4C is a side view of the rear leg assembly of the handcart of FIG. 1A, showing the wire brace and spring pivoted outward from the rear leg assembly;

FIG. 4D is a front view of the handcart of FIG. 1A, showing the front leg assembly of the handcart;

FIG. 5A is a top view of the left and right open pin hinges holding the staged release pivoting axle of the handcart of FIG. 1A, showing the proper orientation of the pin hinges relative to the pivoting axle;

FIG. 5B is a rear view of the support platform, frame, and linkages of the handcart of FIG. 1A, with the rear legs in the down and locked position;

FIG. 5C is a sectional side view of the staged release handle and linkages of the handcart of FIG. 1A, showing the positions of the handle and linkages when the rear legs in the down and locked position;

FIG. 5D is a rear view of the support platform, frame, and linkages of the handcart of FIG. 1A, with the rear legs in the stored position;

FIG. 5E is a sectional side view of the staged release handle and linkages of the handcart of FIG. 1A, showing the positions of the handle and linkages when with the rear legs in the extended position;

FIG. 6A is a side view of the staged release handle of the handcart of FIG. 1A in the vertical position of the first operational orientation;

FIG. 6B is a side view of the staged release handle of the handcart of FIG. 1A being pulled downward from the vertical position of the first operational orientation compressing the release lever spring;

FIG. 6C is a side view of the staged release handle of the handcart of FIG. 1A pivoting laterally to the second operational orientation;

FIG. 6D is a side view of the staged release handle of the handcart of FIG. 1A rotating axially while in the second operational orientation;

FIG. 6E is a side view of the staged release handle of the handcart of FIG. 1A being pushed forward while in the second operational orientation;

FIG. 7A is a sectional side view of the left lift wheel assembly, linkage, and actions of the handcart of FIG. 1A both at rest and while lifting;

FIG. 7B is a sectional side view of the left lift wheel assembly, linkage, and actions of the handcart of FIG. 1A engaging a raised platform;

FIG. 8A is a sectional side view of the left rear leg open hinge assemblage of the handcart of FIG. 1A;

FIGS. 8B-F are sectional side views of the left rear leg open hinge of the handcart of FIG. 1A demonstrating transitions from the stored position to the extended position;

FIGS. 9A-F are sectional side and top exploded views of the spring latch, support frame rib, and assemblage of the handcart of FIG. 1A;

FIGS. 10A-E are sectional side views of the spring latch actions of the handcart of FIG. 1A in operation;

FIGS. 11A-C are side views of the handcart of FIG. 1A showing the sequential steps of the first stage of loading the handcart up to a raised surface;

FIGS. 12A-C are side views of the handcart of FIG. 1A showing the sequential steps of the second stage of loading the handcart up to a raised surface;

FIGS. 13A-C are side views of the handcart of FIG. 1A showing the sequential steps of the third stage of loading the handcart up to a raised surface;

FIG. 14 is a top view of the adjustable leg stop of the handcart of FIG. 1A used to adjust the overall length of the collapsed cart.

Corresponding reference characters indicate corresponding parts throughout the several views of the drawings.

### DETAILED DESCRIPTION

While the invention will be described and disclosed here in connection with certain preferred embodiments, the description is not intended to limit the invention to the specific embodiments shown and described here, but rather the invention is intended to cover all alternative embodiments and modifications that fall within the spirit and scope of the invention as defined by the claims included herein as well as any equivalents of the disclosed and claimed invention.

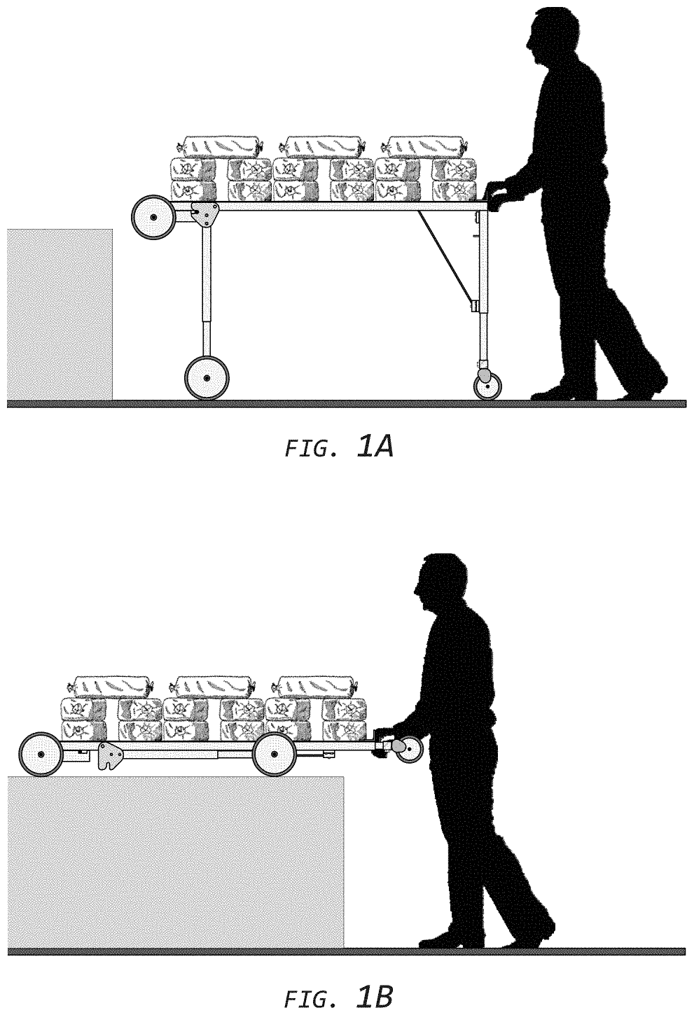

In referring to the drawings, a first representative embodiment of the novel collapsible handcart C of the present invention is shown generally in FIGS. 1-14, where the present invention is depicted by way of example. The collapsible handcart C is shown with an operator carrying items while extended in FIG. 1A and while collapsed in FIG. 1B. In this first representative embodiment 10, the collapsible handcart C comprises five major assemblies, which include a support platform assembly 1, the front leg assembly 2, a rear leg assembly 3, a lift wheel assembly 4, and a staged release assembly 5.

The support platform assembly 1 comprises a support surface 9, a support frame side 10, a support frame front 11, a support frame rib 13, a rear leg storage shelf 15, a left open pin hinge 50, and a right open pin hinge 51.

The front leg assembly 2 comprises a front wheel 40, a front wheel axle 41, a front upper leg 42, a front lower leg 43, a flat hinge 45, and a front leg hinge bolt 48. The rear leg assembly 3 comprises a rear leg castor wheel 60, a rear leg wheel strut 61, an upper rear leg 62, a lower rear leg 63, a rear leg lower strut 64, a rear leg upper strut 65, a wire brace hinge block 66, and a wire brace 67. The lift wheel assembly 4 is comprised of the lifting wheel 20, the lift wheel axle 21, and the lift wheel coupling bar 25. The staged release assembly 5 is comprised of the staged release lever 80, and the drawn latch pin 84.

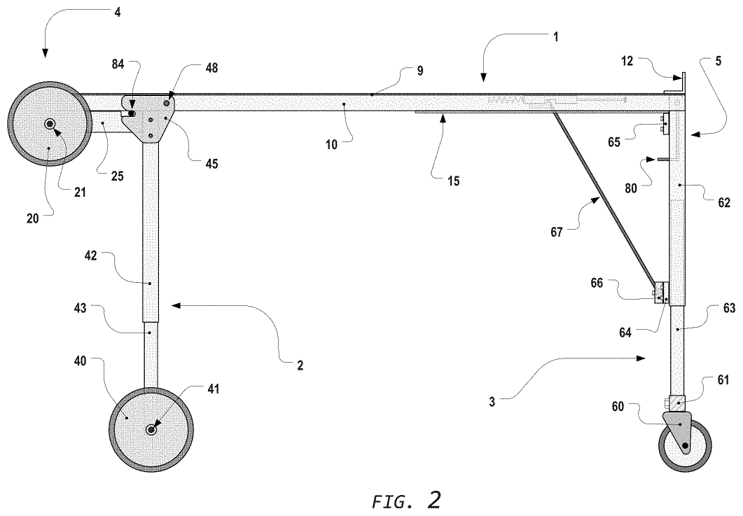

Referring to FIGS. 2, 3 and 5A-D, it can be seen that the support platform assembly 1 is constructed by attaching one of the support frame sides 10 at each end of the support frame front 11 and the support frame rib 13 to the middle of the support frame front 11. The support surface 9 is then placed on that assembly with the support frame push plate 12 on top sandwiching the support surface 9 between it and the support frame push plate 12. The support frame push plate 12 is connected to and provides structural integrity to the support frame sides 10, the support frame rib 13, as well as the left open pin hinge 50 and the right open pin hinge 51 which are all attached to the support frame push plate 12 through the support surface 9. The support surface 9 is also attached to each of the support frame sides 10, the support frame front 11, and the support frame rib 13 for whatever structural integration the intended load requires.

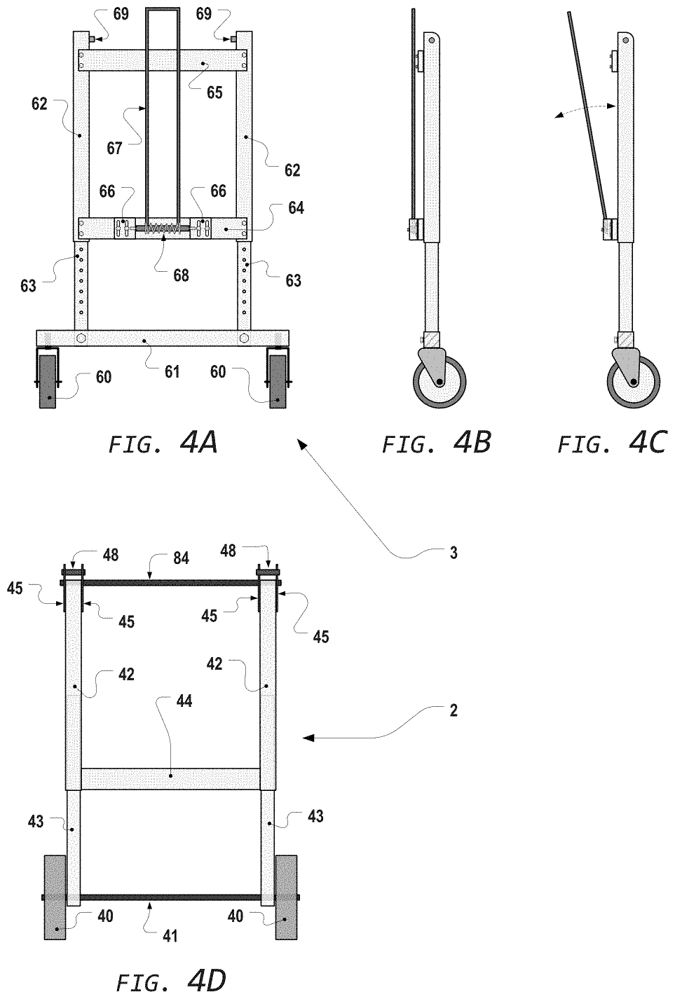

Referring to FIG. 4D, the front leg assembly 2 is constructed by first inserting the front lower legs 43 into the front upper legs 42. The front lower legs 43 have holes every 1 inch for height adjustment and are held in place by aligning the appropriate holes with the bolts going through the front upper legs 42 to attach the front leg strut 44. The front wheel axle 41 is then placed through the bottom ends of the front lower legs 43 and attached the front upper legs 42 to each end of the front wheel axle 41. In FIG. 2 is can be seen that two of the flat hinges 45 are attached to each of the front upper legs 42. Be sure to align the flat hinges 45 latch slot using the drawn latch pin 84. The completed assembly is connected to the support frame with the front leg hinge bolts 48 as show in FIG. 2.

When extended, the front leg assembly 2 supports the front of the support platform assembly 1 (see FIGS. 1A, 2), but when collapsed, the leg pivots around the drawn latch pin 84 to lay flat against the support platform assembly 1 as shown in FIG. 1B at which point it supports the rear of the support platform assembly 1. To keep the support platform assembly 1 level, it is important for the front wheels 40 to align with the lifting wheels 20.

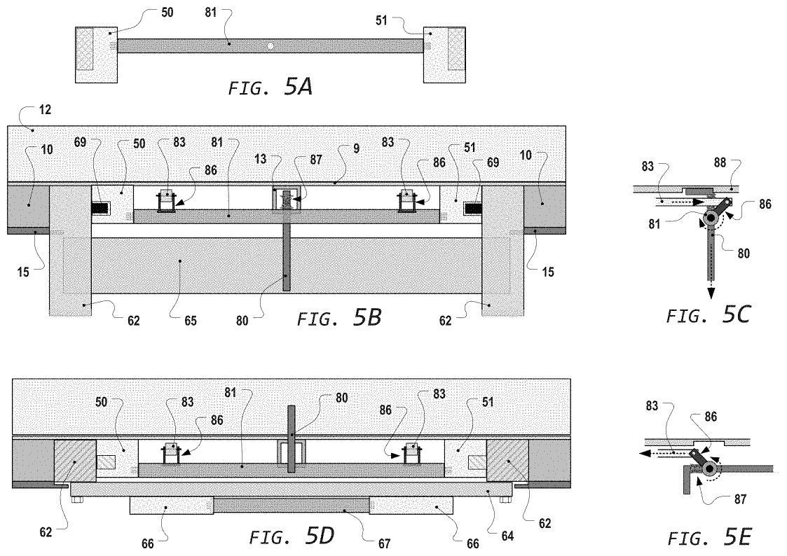

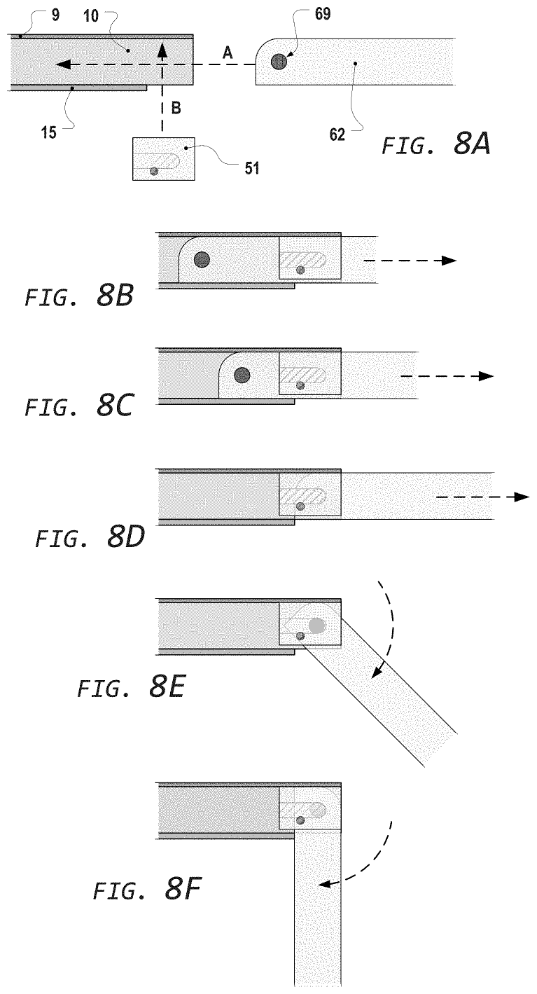

Referring to in FIGS. 5A-D, it is shown that a shelf for storing the rear leg assembly 3 when horizontally collapsed is created by attaching one of the rear leg storage shelves 15 at a distance equal to the width of the upper rear leg 62 away from the rear of each of the support frame sides 10 on the opposite side of the support surface 9. Each of the rear leg storage shelves 15 should be offset toward the support frame rib 13 such to form an inside tray to hold the upper rear legs 62 when between the support frame sides 10 as can be seen in FIG. 5D. During assembly, connect the rear leg assembly 3 by placing it inside the shelf before attaching the left open pin hinge 50 and the right open pin hinge 51 (see FIG. 8A) which are designed to catch the rear leg hinge pin 69 on the upper rear legs 62 allowing the rear leg assembly 3 to pivot into the extended position. The extension pivoting action with the left open pin hinge 50 and the right open pin hinge 51 is illustrated in FIG. 8B-F. FIG. 8B-C showing the upper rear leg 62 and the rear leg hinge pin 69 assembly moving out of the storage shelf. One of ordinary skill in the art will recognize that the rear leg hinge pin 69 becomes trapped in the left open pin hinge 50 and the right open pin hinge 51 in FIG. 8D. In FIG. 8E it can be seen that the front upper leg 42 is allowed to pivot downward because the rear leg storage shelf 15 was attached the distance equal to the width of the upper rear leg 62 from the rear of the support frame side 10 until the upper rear leg 62 is substantially horizontal as seen in FIG. 8F.

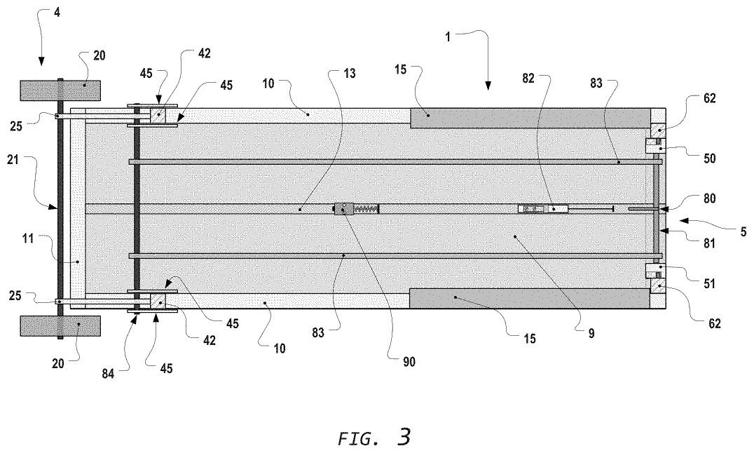

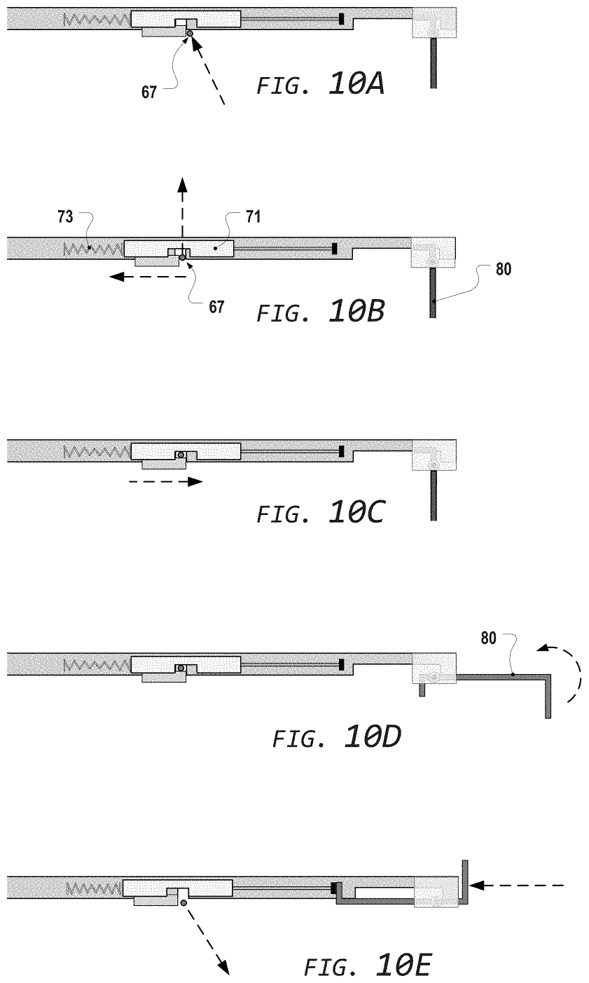

Referring again to FIG. 3, the wire brace release latch 82 is a subassembly that slides inside of the support frame rib 13 and automatically traps and latches the wire brace 67 when the rear leg assembly 3 is extended. The wire brace release latch 82 is not accessible to the operator except by plunging the staged release lever 80 while horizontal and rotated up as illustrated in FIG. 10A-E.

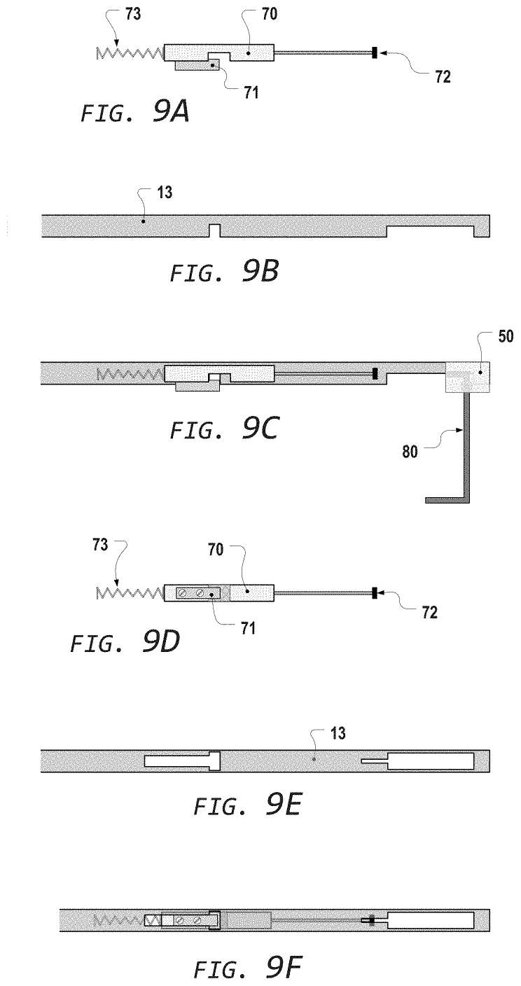

Referring to FIG. 9A-F, the wire brace release latch 82 is assembled by attaching the striker plate 72 to the sliding latch block 70 which is placed inside the support frame rib 13 after the sliding latch compression spring 73. Pressing against the striker plate 72 will compress the sliding latch compression spring 73 enough to attach the latch block catch 71 and hold the wire brace release latch 82 in place. The support frame rib 13 will need a stop screw at an appropriate distance to properly tension the sliding latch compression spring 73 before inserting the wire brace release latch 82, as well as the two slots depicted in FIGS. 9B and 9E which should be appropriately sized to accommodate the latch block catch 71, the wire brace 67, and the staged release lever 80 as per FIG. 9A-F and FIG. 10A-E.

The operation of the wire brace release latch 82 is depicted in FIG. 10A-E where FIG. 10A shows the force acting on the wire brace 67 created by the wire brace spring 68 as the rear leg assembly 3 pivots to the extended position. FIG. 10B shows how the component forces press against the latch block catch 71 to compress the sliding latch compression spring 73 so the wire brace 67 drops into the support frame rib 13 slot where it is trapped by the latch block catch 71 as the sliding latch compression spring 73 decompresses as shown in FIG. 10C. The wire brace release latch 82 releases the wire brace 67 by rotating the staged release lever 80 to the horizontal position as shown in FIG. 10D and then rotating the staged release lever 80 by 180 degrees and then plunging the staged release lever 80 forward against the striker plate 72 compressing the sliding latch compression spring 73 to move the latch block catch 71 out of the way and releasing the wire brace 67 allowing the rear leg assembly 3 to be collapsed as shown in FIG. 10E.

Referring to FIGS. 2-3 and 7A-B, it can be seen that the lift wheel assembly 4 is constructed by connecting two of the lifting wheels 20 on either end of the lift wheel axle 21 which resides in the vertical slot in two of the lift wheel coupling bars 25. The vertical slot in the lift wheel coupling bar 25 allows the lift wheel axle 21 to move or “float” between the bottom and top when resting or bearing weight respectively. Each of the lift wheel coupling bars 25 has a pivoting bar called the pivoting lock bar 23 which has a slightly elongated hole diameter oversized for the lift wheel axle 21 on one end aligned with the vertical slot on the lift wheel coupling bar 25 and through which the lift wheel axle 21 is placed such that any vertical movement of the lift wheel axle 21 causes the pivoting lock bar 23 to pivot. The lift wheel coupling bars 25 are mounted on either side of the support platform assembly 1 front by attaching to both the support frame front 11 and the support frame side 10.

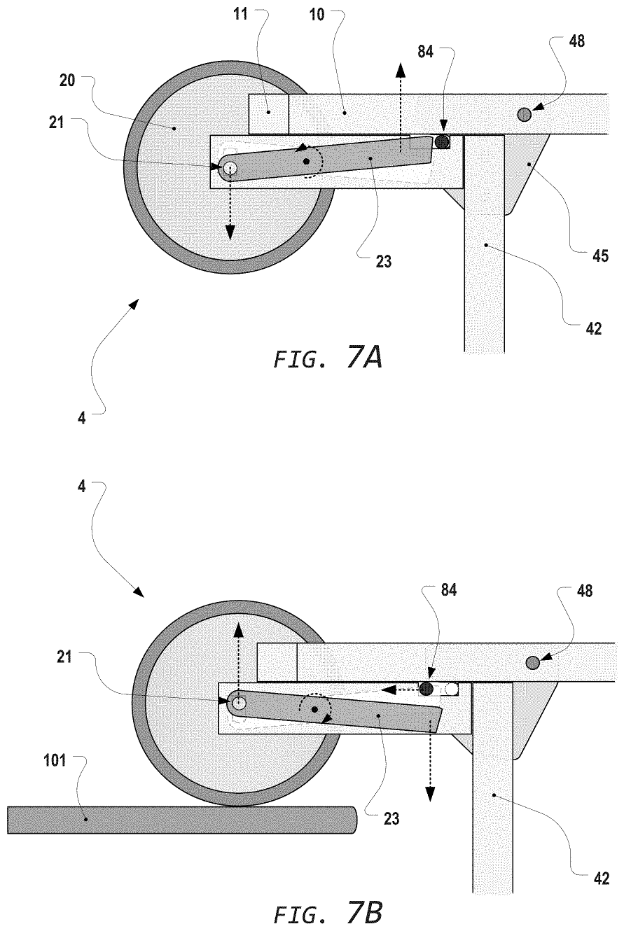

The linkage and action of the lift wheel assembly 4 mechanism can be seen while off the raised surface 101 in FIG. 7A and while on the raised surface 101 in FIG. 7B. In FIG. 7A, the lift wheel assembly 4 is separated from (i.e., not engaging) the raised surface 101 with the wheel 20 cantilevered from the front end of the handcart C such that the lifting wheel 20 and the lift wheel axle 21 are pulled downward by gravity with force sufficient to pivot the pivoting lock bar 23 on the lift wheel coupling bar 25 into a position trapping the drawn latch pin 84 in place and effectively locking the flat hinge 45 and thus the front upper leg 42 in the extended position.

In FIG. 7B, the lift wheel assembly 4 is shown positioned on the raised surface 101 with the raised surface supporting the front of the handcart C such that the lifting wheel 20 and the lift wheel axle 21 are pushed upward supporting the handcart C with force sufficient to pivot the pivoting lock bar 23 on the lift wheel coupling bar 25 into a position freeing the drawn latch pin 84 to be moved out of the flat hinge 45 by releasing the front upper leg 42 to be collapsed by pivoting on the front leg hinge bolt 48. Trapping the drawn latch pin 84 in place prevents movement of the latch pin draw rod 83, the staged release pivoting axle 81, and the staged release lever 80 and effectively prevents the upper rear leg 62 from being released.

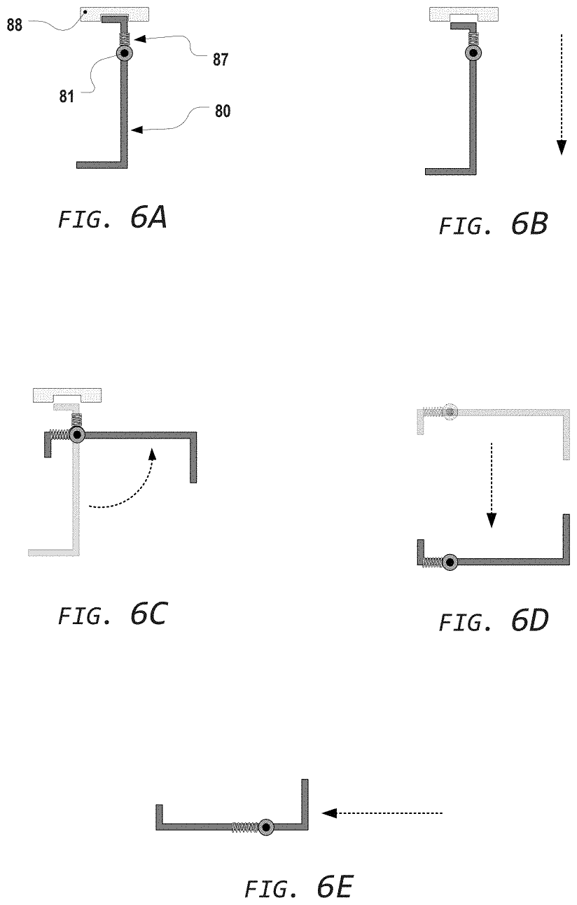

Referring to FIG. 5A-5E, it is shown that the staged release assembly 5 and linkage construction starts with the ends of the staged release pivoting axle 81 mounted into the left open pin hinge 50 and the right open pin hinge 51 as shown in FIG. 5A. The staged release lever 80 is placed through the release lever spring 87 and center hole in the staged release pivoting axle 81 such that it can slide back and forth as shown in FIG. 6D-E. The draw bar linkage arms 86 attach to the staged release pivoting axle 81 on each side of the staged release lever 80 and at a 45 degree offset from the staged release lever 80 axis. Pins are used to connect the draw bar linkage arms 86 to the latch pin draw rods 83 which in turn connect to the drawn latch pin 84 effectively coupling the staged release lever 80 to the drawn latch pin 84 (FIG. 3) such that when the staged release lever 80 is horizontal the drawn latch pin 84 is pushed out of the latch slot on the flat hinges 45 unlatching the front leg assembly 2 (FIG. 5D-E), and when the staged release lever 80 is vertical the drawn latch pin 84 is drawn into latch slot on the flat hinges 45 latching the front leg assembly 2 in place (FIG. 5B-C).

The operation of the staged release assembly 5 is illustrated in FIG. 6A-E. FIG. 6A shows the staged release lever 80 in the vertical position with the release lever spring 87 pushing the staged release lever 80 into the slot on the release lever lock plate 88 to prevent accidental pivoting of the staged release pivoting axle 81. To pivot the staged release lever 80 to the vertical position, it must first be pulled down compressing the release lever spring 87 and releasing the squared end of the staged release lever 80 to vacate the slot on the release lever lock plate 88 as shown in FIG. 6B. The front leg assembly 2 is released as the staged release lever 80 pivots and pushes the drawn latch pin 84 as in FIG. 6C. To release the rear leg assembly 3, the staged release lever 80 must be axially rotated 180 degrees as illustrated in FIG. 6D, or the staged release lever 80 will miss the striker plate 72 when being plunged as shown in FIG. 6E and the rear leg assembly 3 will not release. Hence, the requirement that the staged release lever 80 be axially rotated by 180 degrees provides an additional safety against accidental release of the rear leg assembly 3.

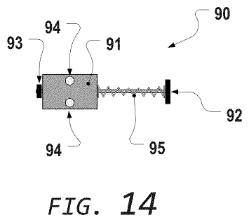

Referring to FIG. 14, the adjustable leg stop 90 has a leg stop block 91, a leg stop striker 92, a leg stop retainer 93, a leg stop compression spring 95, and two leg stop fasteners 94. The leg stop block 91 has a shaft hole sized to the leg stop striker 92 allowing it to slide through. The leg stop striker 92 is tensioned with the leg stop compression spring 95 and held in the leg stop block 91 with the leg stop retainer 93. The adjustable leg stop 90 attaches to the support frame rib 13 with two of the leg stop fasteners 94 at a position on the support frame rib 13 preventing the rear leg assembly 3 from moving further into the support platform assembly 1 and thus adjusting the overall length of the collapsed handcart C. As the rear leg assembly 3 moves into the support platform assembly 1, it hits the leg stop striker 92 compressing the leg stop compression spring 95 such that when the collapsed handcart C is in a truck bed and the tailgate is closed, the wheels of the rear leg assembly 3 are pressed against the tailgate due to the compression of the leg stop compression spring 95 such to keep the collapsed handcart C from rolling forward and backward during transportation.

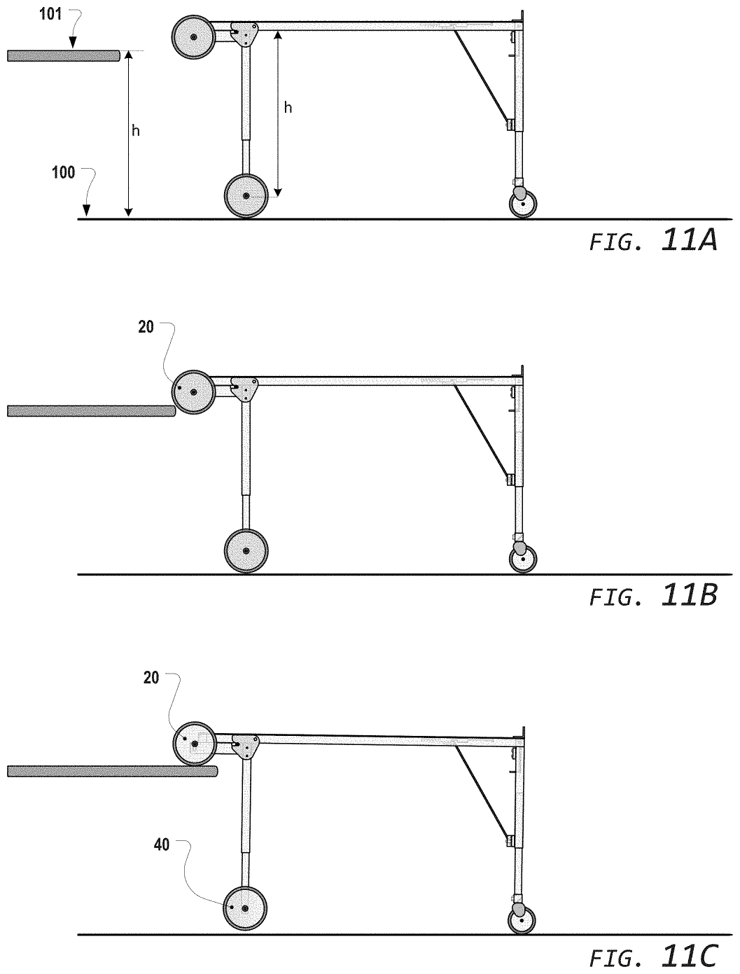

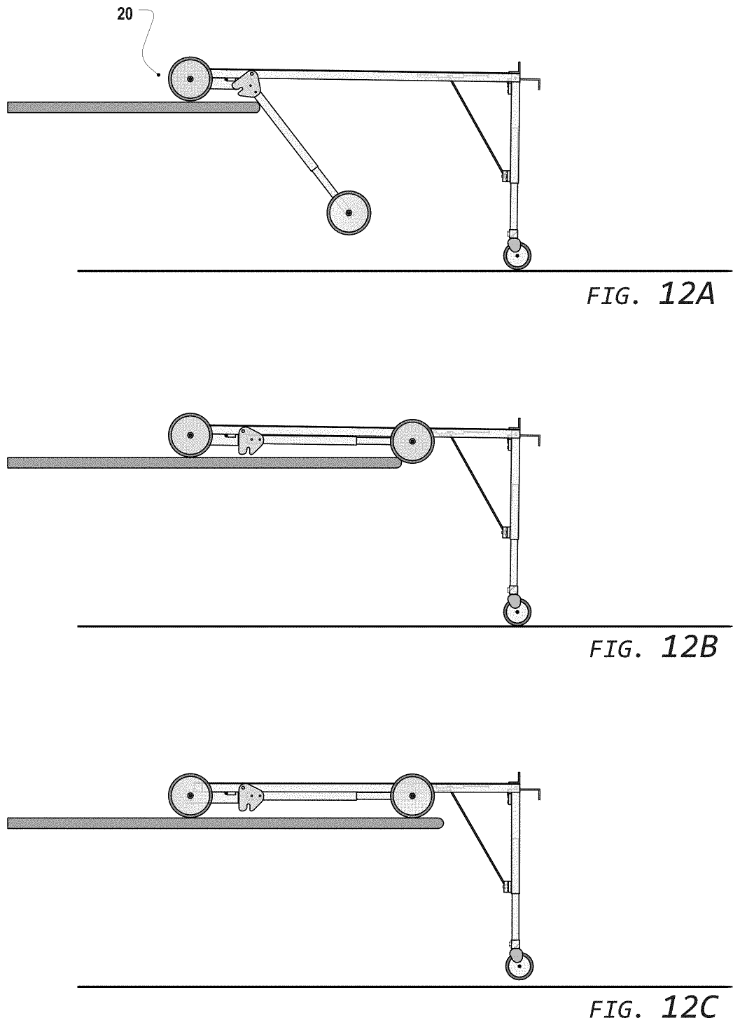

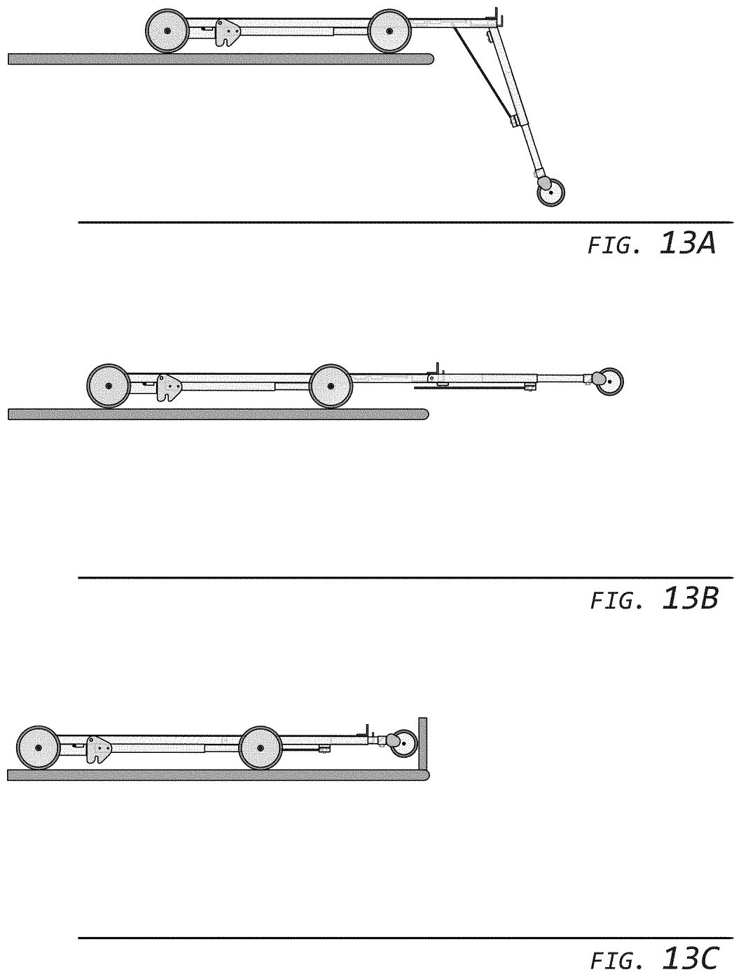

Referring to FIG. 11A-C, FIG. 12A-C, and FIG. 13A-C, the operation of transferring the handcart C from the floor surface 100 to the raised surface 101 and back to the floor surface 100 is depicted sequentially.

FIG. 11A shows the handcart C on the floor surface 100 with both legs extended, supported in the front by the front wheels 40 and the rear by the rear leg castor wheels 60, and the staged release lever 80 vertical (FIG. 6A and FIG. 5C). The front and rear legs should be adjusted so the distance between the front wheel axle 41 and the support frame sides 10 and the height of the raised surface 101 is roughly within ⅓ the diameter of the lifting wheels 20.

FIG. 11B shows the handcart C on the floor surface 100 and the lifting wheels 20 approaching the raised surface 101 at the proper height, supported in the front by the front wheels 40 and the rear by the rear leg castor wheels 60, and the staged release lever 80 is still vertical.

FIG. 11C shows the handcart C after the lifting wheels 20 were pushed onto the raised surface 101, supported in the front by the lifting wheels 20 and the rear by the rear leg castor wheels 60 with no weight on the front wheels 40, and the staged release lever 80 is still vertical but the pivoting lock bar 23 is no longer stopping the operator from releasing the front leg assembly 2 (FIG. 7B).

FIG. 12A shows the handcart C after the operator has pulled the staged release lever 80 down and pivoted it to the horizontal position (FIG. 6A-C), as the operator continues to push the handcart C onto the raised surface 101, the front leg assembly 2 collapses underneath.

FIG. 12B shows the handcart C with the front wheels 40 ready to be pushed onto the raised surface 101.

FIG. 12C shows the handcart C fully supported on the raised surface 101 by the lifting wheels 20 and the front wheels 40 with no weight on the rear leg castor wheels 60.

FIG. 13A shows the handcart C after the operator has rotated and plunged the staged release lever 80 to release the wire brace release latch 82 (FIG. 6D-E). The operator can then pivot the rear leg assembly 3 to the horizontal position (FIG. 13B) and slide the rear leg assembly 3 into the support platform assembly 1 tray (FIG. 13C).

Working backwards depicts the actions taken move the handcart C from the raised surface 101 back to the floor surface 100.

That is, FIG. 13C shows the handcart C fully on the raised surface 101.

FIG. 13B shows how the operator extends the rear leg assembly 3 horizontally from the support platform assembly 1 and in FIG. 13A pivots it into the extended position at which point the wire brace 67 is trapped in the wire brace release latch 82 latching the rear leg assembly 3 in place in FIG. 12C.

With the rear leg assembly 3 latched in place, FIG. 12B shows as the operator continues to pull the handcart C off the raised surface 101 such that the front leg assembly 2 starts to extend in FIG. 12A.

FIG. 11C shows the handcart C with the front leg assembly 2 fully extended, at which time the operator rotates the staged release lever 80 (FIG. 6D) and pivots it from the horizontal to vertical position (FIG. 6A) latching the front leg assembly 2 in place. If the front leg assembly 2 is not latched into place, the operator will know because the staged release lever 80 will not be able to pivot to the vertical position. NOTE: This is important because it assures the operator the front leg assembly 2 is indeed latched in place and the handcart C is safe to come down off of the raised surface 101.

FIG. 11B shows the handcart C as it comes down of the raised surface 101.

It is to be understood that while a certain form of the invention is illustrated, it is not to be limited to the specific form or arrangement of parts herein described and shown. It will be apparent to those skilled in the art that various changes may be made without departing from the scope of the invention and the invention is not to be considered limited to what is shown and described in the specification. One skilled in the art will readily appreciate that the present invention is well adapted to carry out the objects and obtain the ends and advantages mentioned, as well as those inherent therein. Any devices, methods, procedures and techniques described herein are presently representative of the preferred embodiments, are intended to be exemplary and are not intended as limitations on the scope. Changes therein and other uses will occur to those skilled in the art which are encompassed within the spirit of the invention and are defined by the scope of the appended claims. Although the invention has been described in connection with specific preferred embodiments, it should be understood that the invention as claimed should not be unduly limited to such specific embodiments. Indeed, various modifications of the described modes for carrying out the invention which are obvious to those skilled in the art are intended to be within the scope of the following claims.

For example, while the handcart C is depicted with a set of six wheels (the pairs of wheels 20, 40 and 60), the number of wheels can vary. That is, by way of example, the handcart C may be constructed with only one wheel 20 instead of two, or the wheels 40 and 60 may have three or more wheels each instead of two. Further, while the wheels 60 are depicted as rotatable caster wheels, they need not be, and the wheels 40 may be caster wheels if desired. Similarly, the handcart C can comprise more than two sets of collapsible legs and leg assemblies. Moreover, each of the wheels 20, 40 and 60 may be replaced with apparatuses other than wheels that provide mobility, including for example, a sled or rail surface, a track or a ball, so long as such configurations still enable the handcart C to provide the benefits and functions as discussed herein.

It is also not necessary that the rear leg assembly 3 collapse into itself in the manner shown (FIGS. 13B-C), or collapse at all. Rather, the rear leg assembly 3 or portion of the rear leg assembly 3 could, for example, alternatively fold upward over itself and onto the top of the handcart C when on the raised surface. Similarly, the rear leg assembly 3 could be constructed to slide next to the upper frame.

By way of further example, the frame pieces of the handcart C may be constructed in a variety of shapes and sizes, which may include for example, curved or bowed or triangular legs, an oval platform support surface 9, tiered struts, and tubular constructs with non-square cross-sections. In addition, the coil springs 68, 73, 87 and 95, can each be replaced with various mechanical biasing devices or constructs, such as for example, dampers, pistons, and other variety of spring types. Moreover, each of the various release latches and assemblies can be reconfigured or replaced with a variety of mechanical latching or securing devices, or electromechanical assemblies, so long as such configurations still enable the handcart C to provide the benefits and functions as discussed herein.

It is also contemplated that the handcart C may be configured to allow the user to steer the cart during operation. For example, the support surface 9 and support frame 10 of the support platform assembly 1 can include a center, vertically oriented pivot point to allow for variation in the orientation between the front end and the rear end of the handcart C. This may be important when loading the handcart C onto the raised surface after the front wheels have been collapsed so that the rear end can be manipulated independently from the front end. Of course, a wide variety of configurations to enable this function will be recognized by one of ordinary skill in the art.

Hence, additional variations or modifications to the configuration of the novel mechanism of the present invention, shown by way of example at C, may occur to those skilled in the art upon reviewing the subject matter of this invention. Such variations, if within the spirit of this disclosure, are intended to be encompassed within the scope of this invention. The description of the embodiments as set forth herein, and as shown in the drawings, is provided for illustrative purposes only and, unless otherwise expressly set forth, is not intended to limit the scope of the claims, which set forth the metes and bounds of my invention. Accordingly, all matter contained in the above description or shown in the accompanying drawings should be interpreted as illustrative and not in a limiting sense.

When describing elements or features and/or embodiments thereof, the articles “a”, “an”, “the”, and “said” are intended to mean that there are one or more of the elements or features. The terms “comprising”, “including”, and “having” are intended to be inclusive and mean that there may be additional elements or features beyond those specifically described.

I claim:

1. A collapsible handcart comprising:
a. a substantially rigid support platform having a substantially flat upward facing support surface, the platform being constructed to be capable of vertically supporting a predetermined load;
b. a support frame, the support frame providing structural support to the support platform, the support frame having a front end, a rear end opposite the front end, a left side, and a right side opposite the left side;
c. a collapsible front leg pivotally attached to the support platform in proximity to the front end of the support frame;
d. a first interlock operatively associated with the collapsible front leg, the first interlock preventing the front leg from collapse when locked and allowing the front leg to collapse when unlocked;
e. a front leg latch having an open position and a closed position, the front leg latch preventing the front leg from rotating when the latch is in the closed position;
f. a collapsible rear leg pivotally attached to the support platform in proximity to the rear end of the support frame;
g. a second interlock operatively associated with the collapsible rear leg, the second interlock preventing the rear leg from collapse when locked and allowing the rear leg to collapse when unlocked;
h. a rear leg latch having an open position and a closed position, the rear leg latch preventing the rear leg from rotating when the latch is in the closed position;
i. a lift wheel attached to the front end of the support frame and operatively associated with the first interlock, the lift wheel having a first position in which the lift wheel locks the first interlock, the lift wheel having a second position in which the lift wheel unlocks the first interlock; the first position being lower than the second position;
j. a release assembly operatively associated with the front leg latch and with the second interlock, the release assembly having a release latch, the release latch having a first position and a second position and a third position, the release latch activating the release assembly to unlock the front leg latch when the release latch is in the second position, the release latch unlocking the second interlock when the release latch is in the third position.

2. A collapsible handcart comprising:
a. A support platform comprising:
i. a support surface
1) A flat table-like structure capable of physically supporting of attaching one or more items
ii. a support frame
1) provides structural support to the support surface
2) houses various mechanical linkages
iii. Having a front end and a rear end; and
iv. a left side and a right side (standing at rear facing front)
b. A Front leg
i. a vertical extended position
ii. a horizontal collapsed position
iii. Pivotally connected to the front of the support platform
iv. a Front leg Release Latch
1. secures the extended position when latched
2. allows pivoting to the collapsed position when unlatched
v. capable of supporting weight while latched in the extended position
vi. capable of supporting weight while in the horizontal collapsed position
c. A Rear leg
i. a vertical extended position
ii. a horizontal collapsed position
iii. Pivotally connected to the rear of the support platform while in the extended position
iv. A rear leg release latch
1. When latched secures the Rear leg in the extended position
v. Capable of supporting weight when latched in the extended position
vi. Stored elsewhere while in the collapsed position
d. A Lift Wheel System
i. coupled to the front of the support platform
ii. a wheel that lifts the support platform by converting the platform's forward motion into upward motion (climbing)
iii. senses when engaged in lifting or not lifting
iv. acts as a leg release safety by preventing legs from being released when not lifting
e. Staged Release
i. latches and unlatches the Front leg Release Latch
ii. unlatches the Front leg Release Latch only when Front leg Release Latch is unlocked
iii. unlatches the Rear leg release latch only after Front leg Release Latch is unlatched
iv. prohibits transition between unlatching operations in a single uninterrupted motion

3. The handcart of claim 2, wherein the support platform houses the rear leg when in the collapsed position.

4. The handcart C of claim 2 wherein the support platform has an adjustable leg stop that limits the rear leg housing depth allowing the collapsed handcart C overall length to be adjusted to prevent unwanted movement during transportation.

5. The handcart of claim 2, wherein the front leg comprises
a. a height adjustable wheeled leg connected to the right side of the platform
b. a height adjustable wheeled leg connected to the left side of the platform
c. one or more struts connecting the two legs together to provide support and maintain distance between the legs
d. one or more flat hinges
i. pivotally connecting each leg to the platform
ii. having a latch slot to allow a drawn latch pin to align and fasten hinged leg in the extended position

6. The handcart of claim 2, wherein
a. The front leg latch can be locked to circumvent release
b. the lift wheel system acts as a safety by
i. locking the Front leg Release Latch when not bearing weight
ii. unlocking the Front leg Release Latch when bearing weight

7. The handcart of claim 6, wherein the Lift Wheel System comprises
a. a right side lifting wheel;
b. a left side lifting wheel;
c. a connecting axle between the two lifting wheels
d. a lift wheel coupling bar connecting to the front of the platform
i. floating axle slot that allows the connecting axle to move up when the lifting wheels bear weight;
ii. a flat hinge latch pin slot to guide the drawn latch pin in and out of the flat hinge latch slot;
iii. a pivoting lock bar connected to the floating axle
1. blocks the drawn latch pin when the lifting wheels bear no weight; and
2. unblocks the drawn latch pin when the lifting wheels do bear weight.

8. The handcart of claim 2, wherein the Rear leg comprises
a. a height adjustable wheeled right leg connected to the right side of the platform;
b. a height adjustable wheeled left leg connected to the left side of the platform;
c. one or more rear leg struts connecting the two legs together to provide support and maintain distance between the legs; and
d. right and left open pin hinges
i. pivotally connecting the respective leg by trapping the hinge pin while in the extended position; and
ii. horizontally releasing the respective leg hinge pin while in the collapsed position to allow horizontal movement in and out of the support platform.

9. The handcart of claim 8 wherein the rear leg release latch comprises
a. a wire brace and spring consisting of
i. a wire brace pivotally connected to the Rear leg;
ii. a torsion spring tensioning the wire brace to pivot toward the Rear leg pin hinges so as to
1. lay pressed flat against the Rear leg while in the collapsed position; and
2. angled away from the Rear leg pin hinges and pressing against the support platform while in the extended position.
b. a wire brace release latch consisting of
i. a sliding latch block and catch attached to the support platform and wherein the latch block and catch can slide back and forth along the support platform forward axis;
ii. a compression spring tensioning the sliding latch block and catch to the closed (latched) position;
iii. a striker plate connected to the sliding latch block such that pressing the striker plate slides the latch block into the unlatched position can only be pressed by using the Staged Release;
wherein pivoting the Rear legs from the collapsed position to the extended position forces the wire brace to travel along the support platform away from the Rear legs and automatically become latched by the wire brace release latch.

10. The handcart of claim 2, wherein the Staged Release comprises
a. a pivoting axle consisting of
i. a round bar;
ii. a transverse circular plunge hole in the middle;
iii. pivot mount points of reduced diameter on both ends;
iv. two parallel draw bar linkage arms one each on either side of the plunge hole mounted at a 45 degree offset to the plunge hole center axis;
b. a plunge lever consisting of
i. a plunge rod located inside the plunge hole;
ii. when in a horizontal position
1. can be plunged through pivoting axle;
2. can be rotated 180 degrees from a position A to position B;
c. two drawbars connecting the pivoting axle linkage arms to the front leg latch release
wherein
i. The pivoting axle can only be rotated when the plunge rod is un-plunged and rotated to position A;
ii. when the pivoting axle is rotated such that the plunge rod is
1. vertical, the Front leg Release Latch is latched;
2. horizontal, the Front leg Release Latch is un-latched
iii. the plunge lever
1. can only be plunged when in the horizontal position; and
2. releases the Rear leg Release Latch if plunged while rotated to position B.
